(19) United States
(12) Patent Application Publication
(10) Pub. No.: US 2014/0060717 A1
(43) Pub. Date: Mar. 6, 2014

(54) TIRE WITH TREAD HAVING BRIDGED AREAS WITH SPLIT CONTACT FACES WITHIN A LATERAL GROOVE

(71) Applicants: MICHELIN RECHERCHE ET TECHNIQUE S.A., Granges-Paccot (CH); COMPAGNIE GENERALE DES ETABLISSEMENTS MICHELIN, Clermont-Ferrand (FR)

(72) Inventors: David Scott Morgan, Greenville, SC (US); Eric AJ Berger, Loubeyrat (FR)

(73) Assignees: MICHELIN RECHERCHE ET TECHNIQUE S.A., Granges-Paccot (CH); COMPAGNIE GENERALE DES ETABLISSEMENTS MICHELIN, Clermont-Ferrand (FR)

(21) Appl. No.: 14/114,726

(22) PCT Filed: Apr. 29, 2011
(86) PCT No.: PCT/US11/34431

§ 371 Date: Oct. 29, 2013

(51) Int. Cl. B60C 11/13

(52) U.S. Cl. CPC B60C 11/1307
USPC 152/209.21

(57) ABSTRACT

This invention relates generally to tires having treads that have a configuration and/or properties for maintaining hydroplaning resistance and improving rolling resistance, and, more specifically, to a tire that has a tread with bridged areas found in its lateral grooves that are configured to maintain hydroplaning resistance and snow traction while also improving rolling resistance.

### BACKGROUND OF THE INVENTION

1. Field of the Invention

This invention relates generally to tires having treads that have a configuration and/or properties for maintaining hydroplaning performance and improving rolling resistance, and, more specifically, to a tire that has a tread with bridged areas found in its lateral grooves that are configured to maintain hydroplaning performance and snow traction while also improving rolling resistance.

2. Description of the Related Art

The reduction of the consumption of energy by vehicles as they travel has become an important goal due to the increase in fuel prices. In many cases, this need affects the development of tires, requiring them to take into account the problem of rolling resistance. Accordingly, tire designers need to design tires having lower rolling resistance. Rolling resistance is an indicator of the energy loss of a tire due to rolling, which in turn results in the generation of heat. This loss heat from the tire is a significant contributor to the total energy loss by the vehicle during its movement. By reducing the rolling resistance of the tire, less energy is consumed by the vehicle for a given journey, as a result, the user spends less money to travel.

In particular, it is known that the rolling resistance of a tire is directly related to energy losses in the tire, which in turn, is dependent on the characteristics of the hysteresis of the mixtures of rubber employed in the tire, especially those of the tread of the tire. The tire's energy loss is also dependent on the deformations that the tread rubber undergoes as the tire rolls into, through and out of the contact patch as well as the deformations of the tire components outside of the tread. For example, if one considers what occurs during the rolling of the tire, that in the zone of contact or rolling patch, the tread is compressed in a direction that is perpendicular to the ground (radial direction of the tire) where the contact occurs. This compressive solicitation, driven by the weight of the vehicle as well as the tread's reaction to vertical asperities in the road surface, consumes energy through shear deformation, driven by the Poisson effect. Also, shearing forces and resulting energy losses are exerted on the tread as it deforms to meet the ground in the circumferential and lateral directions of the tire, due to the curved structure of the tire conforming to the road surface. Finally, under pure rolling in the contact patch, shear forces in the rolling direction are naturally developed in the tread between the belts and the adherent contact with the ground. These shear forces under pure rolling also consume energy.

Consequently, one way to decrease these energy loss effects and the resulting increase in rolling resistance associated with them, is to add features that decrease the deformation of the tread as the tire rolls into, and out of the contact patch. Yet, another possibility for reducing these energy losses concerns the way in which the tread is equipped with incisions or notches to reduce the strains placed on the tread as it rolls into and out of the contact patch. For example, it is known in European Patent No. EP0787601 that it is possible to achieve this goal by configuring the tread with a plurality of incisions that are oriented laterally that have a specified spacing according to the geometrical dimensions of the tire. While this technique works for lowering rolling resistance and can be effective for snow traction, it may not have a significant impact on hydroplaning resistance.

Accordingly, it is desirable to find a construction for the tread of a tire that is able to lower rolling resistance by limiting compression and shear losses, while at the same time maintain the hydroplaning performance of the tire. In addition, it would be advantageous if the solution maintained snow traction performance as well.

### SUMMARY OF THE INVENTION

In one embodiment, the present invention includes an apparatus that comprises a tread for use with a tire having laterally and circumferentially extending grooves that define tread blocks. At least one of said tread blocks has a lateral surface that is located within one of said lateral grooves that has one or more split bridges thereon that do not make contact with the opposing tread block or any portion protruding therefrom. Furthermore, this apparatus is characterized in that the ratio of Dₜ/D_{g}, which is the ratio of the distance from the top of the tread to the top of a bridge to the depth of the lateral groove, is in the range of 10 to 40%; the ratio of D_{b}/D_{g}, which is the ratio of the distance from the bottom of the lateral groove to the bottom of a bridge, is in the range of 15 to 50%; the ratio of the aggregate widths, Wₜₒₜ, of the bridges found along this surface to the width of this lateral surface, W_{b}, of the tread block to should be in the range of 30 to 80%; and the ratio of the summation of the lateral surface areas, Sₜₒₜ, of the bridges to the surface area, S_{b}, of the lateral surface of a tread block is in the range of 10 to 40%.

In such a case, there may be split bridges that are found within a plurality of lateral grooves that are configured as described above and in some embodiments, all the lateral grooves may have split bridges configured as described above. When split bridges are found within a plurality of lateral grooves, these split bridges may be in lateral alignment with each other. Sometimes, they are staggered from each other in the lateral direction of the tire.

In some embodiments, the apparatus further comprises a tire having a carcass and a summit belt package having a top belt and a bottom belt to which said tread is attached.

In other embodiments, the tire defines a dimension E, which is the distance from the top portion of the top belt to the average position of the top surface of the split bridges in the radial direction of the tire, and another dimension F, which is the distance from the axis of rotation X-X of the tire to the average position of the top surface of the split bridges in the radial direction of the tire, wherein the ratio of E/F is in the range of 1.5 to 4%. In some cases, the tire is a 225/50R17 sized tire.

In some cases, said one or more split bridges that extend from one lateral surface of a tread block found within a lateral groove has a counterpart split bridge that extends from the opposite lateral surface of an adjacent tread block such that a small gap is defined between the opposing split bridges. The location of the gap or split may be found anywhere along the width of the lateral groove or may be at the halfway or midpoint of the lateral groove.

In yet further embodiments, the gap located between a split bridge and an adjacent split bridge or tread block is about 0.5 mm or less.

In some embodiments, the end surface of one split bridge that defines the gap between the split bridges has an undulating profile for helping to limit lateral movement of a tread block when the tread block is in the contact patch.

The cross-sectional shape of a split bridge may be ovular or elliptical, rectangular, triangular or any arbitrary shape that is desired. The dimensions of these shapes may also be altered as needed.

In other embodiments, the bridge may have radii from its intersection from the lateral surface of the tread block to it free end.

In some versions of the split bridges, the distance from the top of the tread to the top of a bridge, Dₜ, is in the range of between 0.5 to 2.5 mm while the distance from the bottom of a lateral groove to the bottom of a bridge, D_{b}, is in the range of 0.9 to 4.0 mm. In such a case, the depth, D_{g}, of the lateral groove may be in the range of 5.5 to 10.0 mm and may actually be 8.3 mm.

The foregoing and other objects, features and advantages of the invention will be apparent from the following more detailed descriptions of particular embodiments of the invention, as illustrated in the accompanying drawing wherein like reference numbers represent like parts of the invention.

### BRIEF DESCRIPTION OF THE DRAWINGS

FIG. 1 is a fragmentary perspective view of a lateral groove of a tire that has split bridges therein according to a first embodiment of the present invention where the height of the split bridges in the radial direction of the tire is relatively large;

FIG. 2 is a fragmentary perspective view of a lateral groove of a tire that has split bridges therein according to a second embodiment of the present invention where the thickness of the split bridge in the radial direction of the tire is relatively small and a large radius is present on the edges of the bridge to aid in water flow through the groove and demolding of the mold blade that forms the bridge and groove;

FIG. 3 is a fragmentary perspective view of a lateral groove of a tire that has split bridges therein according to a third embodiment of the present invention where two differently sized and configured bridges are present;

FIG. 4 is a mold blade that forms the groove and split bridges shown in FIG. 3;

FIG. 5 is a mold blade that forms yet another configuration of split bridges that have a substantially rectangular profile;

FIG. 6 is a mold blade that forms another configuration of split bridges that have a substantially ovular profile;

FIG. 7 is sectional view of a shoulder tread block and an intermediate tread block taken along a lateral plane of the tire showing dimensions of the split bridges made by the mold blades shown in FIGS. 4 and 6;

FIG. 8 is a top view of a tread showing split bridges that extend from only side of a lateral groove;

FIG. 9 is a top view illustrating that the gap or incision in the split bridge may be straight;

FIG. 10 is a top view of another version of the split bridge where the gap or incision that splits the bridge has a saw tooth or zig zag profile;

FIG. 11 is a sectional view along a lateral plane of a tread showing multiple split bridges that are positioned at different radial heights of the tire; and

FIG. 12 is a top view of a tire tread where the split bridges are not aligned laterally from one lateral groove to the next but alternate laterally instead.

### DEFINITIONS

By groove, it is meant any channel in the tread of a tire that has two opposing sidewalls that lead from the top surfaces of the tread and that are spaced apart by at least 1.5 mm, i.e. that the average distance separating the sidewalls between the top opening of the channel and the bottom thereof is on average 1.5 mm or more.

By a sipe, it is meant any incision that is less than 1.5 mm and has sidewalls that come into contact from time to time as the tread block or rib that contains the incision rolls into and out of the contact patch of the tire as the tire rolls on the ground.

The circumferential direction, C, is the direction of the tire along which it rolls or rotates and that is perpendicular to the axis of rotation of the tire.

The lateral direction, L, is the direction of the tire along the width of its tread that is substantially parallel to the axis of rotation of the tire. However, by lateral groove, it is meant any groove whose general direction or sweep axis forms an angle with the purely lateral direction that is less 45 degrees.

The radial direction, R, is the direction of a tire as viewed from its side that is parallel to the radial direction of the generally annular shape of the tire and is perpendicular to the lateral direction thereof.

### DETAILED DESCRIPTION OF PARTICULAR EMBODIMENTS

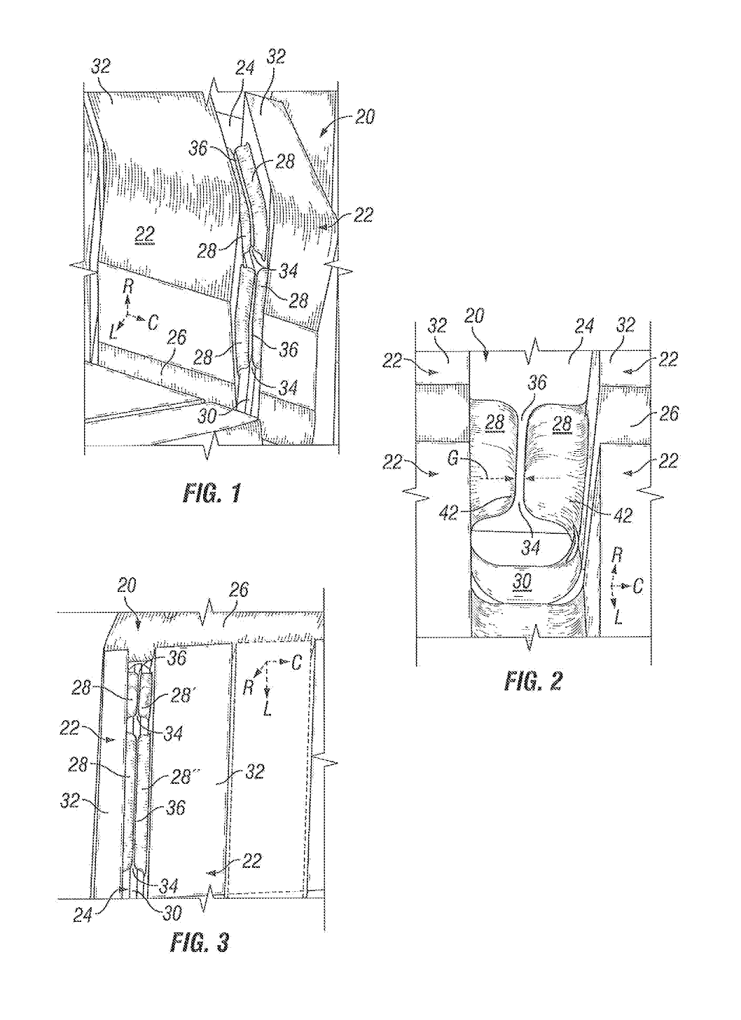

Looking at FIGS. 1-3, a tire 20 having lateral L, circumferential C and radial R directions with tread blocks 22 that are defined by lateral and circumferential grooves 24, 26 is shown. These figures also show different versions of bridges 28 found within the lateral grooves 24 that have a split configuration and that are spaced a predetermined distance from the bottom surface 30 of a lateral groove 24 and from the top surface 32 of a tread. By introducing rubber or bridging in the lateral grooves 24, the evacuation and absorption of water is usually limited, causing the resistance of the tire to hydroplaning to degrade, which means that the tire will hydroplane at lower speeds. However, with the present invention, there is an open channel 34 found below the bridging, which allows for water to pass through the lateral groove throughout the life of the tire. Hence, hydroplaning performance is not deleteriously affected.

In like fashion, bridging usually involves the use of a solid section of rubber that spans from tread block to the next in order to limit tread block deformation due to compression and shear forces as the tread block rolls into and out of contact with the ground. However, this type of bridging does not allow the tread block to effectively bend as it enters or exits the contact patch, and therefore results in higher energy losses. Consequently, the present invention includes a split configuration of the bridge so that one tread block is free to move away from another tread block, as the tread block rolls into and out of contact with the ground, thus deformation due to bending can be minimized. This, in turn, allows the rolling resistance of the tread to be lowered. The gap 36 created by this split configuration is sufficiently small so that it can be closed quickly, making the bridges 28 contact each other so that the tread block 22 will not deform significantly due to compressive and shear forces when it is in the contact patch. This also allows the rolling resistance of the tread to be lowered. Thus, the placement and configuration of the split bridges 28 relative to the lateral grooves 24 and the tread blocks 22 impacts the rolling resistance and wet performances of the tire.

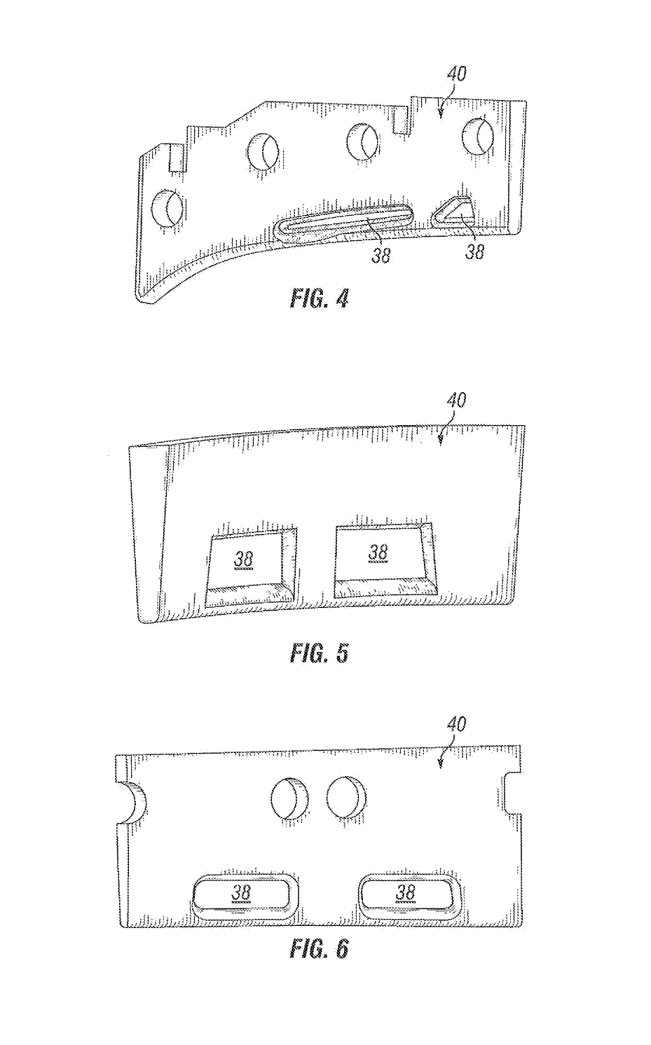

Looking at FIGS. 1 and 2, it can be seen that the shape of the bridges 28 can vary. For example as shown in FIG. 1, the bridges 28 can be separated into two or more units that have a relatively deep cross-section in the radial direction R of the tire. On the other hand as shown in FIG. 2, the bridge 28 can be a single thin and long unit. Yet a third embodiment is shown in FIG. 3, where a relatively small sized bridge 28′ is adjacent to a larger sized bridge 28″. Focusing now FIGS. 4, 5 and 6, the shapes and sizes of different bridges 28 can be understood by looking at the cavities 38 of mold blades 40 that form them, realizing that the bridges 28 and grooves 24 of the tread will be complimentary shaped and be in the form of a negative image as compared to the geometry of the mold blade 40. Hence, the cross-sectional shape of the bridges 28 could have any desired shape that suits a particular application, such as triangular (see FIG. 4), rectangular (see FIG. 5), or ovular (see FIG. 6). These mold blades 40 may be manufactured by means commonly known in the art.

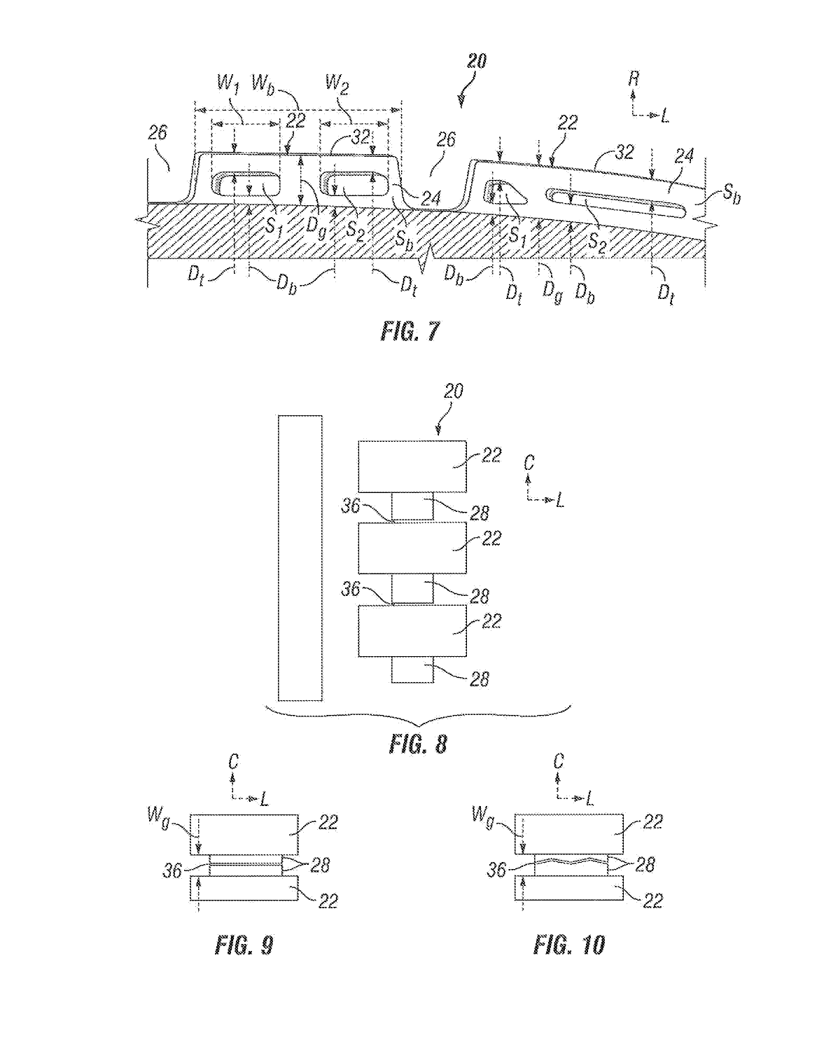

Looking now at FIG. 7, it shows a third of the width of a tire tread along the lateral direction L of the tire 20, starting at one shoulder, which uses an embodiment of the present invention. In particular, the tread is formed using the mold blade 40 depicted by FIG. 4 in the shoulder area while the mold blade 40 depicted in FIG. 6 creates the bridges 28 found in the adjacent or intermediate tread block 22. Looking closely at this figure, some dimensions that can be used by a designer to achieve the unexpected and critical results of the present invention can be seen. The distance from the top of the tread 32 to the top of a bridge, Dₜ, is preferably in the range of between 0.5 to 2.5 mm while the distance from the bottom 30 of a lateral groove to the bottom of a bridge, D_{b}, should preferably be in the range of 0.9 to 4.0 mm. In cases where there are blends, radii or chamfers that transition from the lateral surface of a lateral groove, dimensions Dₜ and D_{b} exclude such features. In the case of a fluted wine bottle shape, the D_{b} measurement is taken at the inflection of the curve where the positive and negative radii join.

Along the lateral surface of a tread block, the ratio of the aggregate widths, Wₜₒₜ, of the bridges found along this surface to the width of this lateral surface, W_{b}, of the tread block should be in the range of 30 to 80% for the most effective reductions in energy loss. For example, Wₜₒₜ would be the sum of W₁ and W₂ where two bridges are present along the lateral surface of a tread block and W₁ and W₂ are the widths of the two bridges. For this particular embodiment, the depth, D_{g}, of the lateral grooves can range from 5.5 to 10.0 mm. Alternatively, the ratio of the summation of the lateral surface areas, Sₜₒₜ, of the bridges to the surface area, S_{b}, of the lateral surface of a tread block assuming no bridges are present should be in the range of 10 to 40%. For example, Sₜₒₜ would be the sum of S₁ and S₂ where two bridges are present along the lateral surface of a tread block and S₁ and S₂ are the surface areas respectively of these bridges.

In many cases, the distance or gap, G, between each split bridge (best seen in FIG. 2) is the same and is preferably 0.5 mm or less so that the split bridges contact each other quickly as the tread blocks along which they are found roll into and out of the contact patch. For the tire discussed later, the gap was in fact 0.15 to 0.2 mm. While the bridges 28 are split half way across the width of the lateral groove 24, it is contemplated that the split could occur anywhere along the width of the lateral groove 24. At an extreme, the bridge 28 could extend only from one side of the groove 24 to the opposing lateral surface of an adjacent tread block 22, as best seen in FIG. 8. Also, the gap 36 does not need to be straight (see FIG. 9) but could be have a zig zag configuration (see FIG. 10) or some other arbitrary shape either in the L-C plane or C-R plane. The advantage of having an interlocking shape such as a zig zag shape is that it helps the bridges 28 prevent deformation of the block 22 both circumferentially C as well as laterally L, which helps to decrease rolling resistance even more. Also, the gap 36 itself may vary in width. The surfaces of the bridges near the gap may be smooth, textured or some combination thereof. The width, W_{g}, of the lateral groove 24 may be 1.5 to 10 mm for any of the embodiments discussed herein.

Alternatively, the design of these split bridges can be put into dimensionless parameters so that the present invention can be applied to tires having different sizes. For example, the ratio of Dₜ/D_{g}, which is the ratio of the distance from the top of the tread to the top of the bridge to the depth of the lateral groove, should be in the range of 10 to 40%. Similarly, the ratio of D_{b}/D_{g}, which is the ratio of the distance from the bottom of the lateral groove to the bottom of the bridge, should be in the range of 15 to 50%. Similarly as stated previously, along the lateral surface of a tread block, the ratio of the aggregate widths, Wₜₒₜ, of the bridges found along this surface to the width of this lateral surface, W_{b}, of the tread block should be in the range of 30 to 80%.

Looking back at FIG. 2, a preferred cross-sectional shape as viewed in the lateral direction L of the tire 20 is shown. This shape on the inferior surface of the split bridge can be compared to that of a fluted wine bottle where radii 42 are used where the bridges 28 intersect with the lateral surfaces of the tread blocks 22 and where the bridges terminate at their free ends. This helps to reduce stress concentrations as the bridges contact each other, helping to keep them intact during cyclic use. In addition, these radii are three dimensional in nature, which allows them to funnel water into the lower passage 34 found below the bridge 28. This promotes laminar flow of water through this channel, which contributes to maintaining the hydroplaning resistance of the tire. Also, these radii aid in demolding the mold blade that forms the groove and bridges. In some cases, the size of the radius used is almost half the thickness of the bridge.

In order to optimally reduce rolling resistance, these split bridges that are configured per the above guidelines, should be found on the lateral surfaces of every tread block of the tire across the entire width of the tire in its lateral direction. This does not have to be case however if other performances are affected deleteriously by such a universal use of these bridges. Thus, applications where only a portion of the lateral surfaces of tread blocks have such bridges are also contemplated.

Turning now to FIG. 11, another application of the present invention is shown where a tire 20 that has at least two belts 44, 46 found beneath the tread is used in conjunction with bridges 28 that are configured as previously described. In addition, such a tire will usually have circumferentially oriented grooves 26 or grooves oriented at an oblique angle greater than 45 degrees to the lateral direction L of the tire for the absorption of water and/or snow as the tire rolls. This tire also has lateral grooves 24 that define lateral surfaces on which the split bridges 28 are found. The tire defines a dimension E, which is the distance from the top portion of the top belt 44 to the average position of the top surface of the split bridges 28 in the radial direction R of the tire, and another dimension F, which is the distance from the axis of rotation X-X of the tire to the average position of the top surface of the split bridges in the radial direction of the tire. The inventors have found that it is preferred that the ratio of E/F be in the range of 1.5 to 4%. This is particularly applicable to a 225/50R17 sized tire where E/F is 2.1%, or put into actual dimensions, E is 6.8 mm and F is 322 mm.

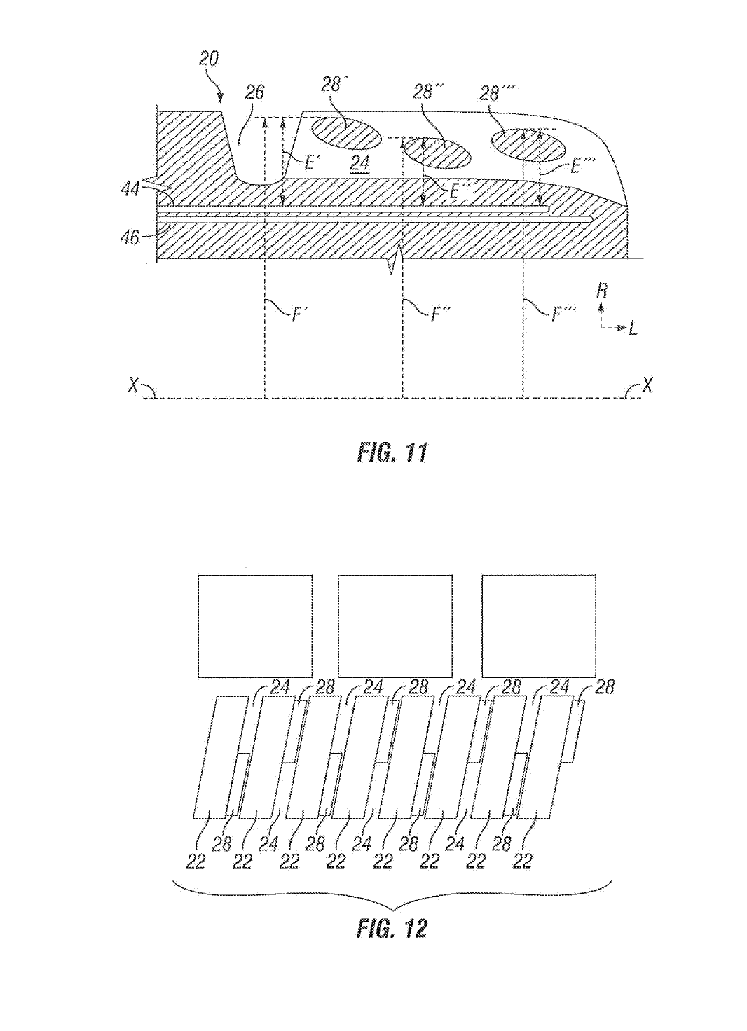

Looking more closely at FIG. 11, there are three bridges 28′, 28″, 28′″ shown in a lateral cross-sectional view of the tire. Each is at a slightly different radial height with respect to the tire. Therefore, the E value and F value of each bridge (E′, E″, E′″ as well as F′, F″, F′″) would be averaged. The resulting values, Eₐᵥₑ and Rₐᵥₑ, would then be used to obtain the ratio Eₐᵥₑ/Rₐᵥₑ. Ideally, this ratio would fall into the range of 1.5 to 4%. It should also be noted that the configuration and position of the bridges found in one lateral groove does not necessarily need to be the same as the bridges found in an adjacent lateral groove. For example, looking at the tread such as that shown in FIG. 12, the bridges 28 can have a staggered position from one lateral groove 24 to the next. In other cases, the bridges will be aligned from one lateral groove to the next in the lateral direction as seen in FIG. 8.

As can be seen, these embodiments provide a way to add rubber volume to the lateral grooves of a tire only in places where it is most effective for reducing the rolling resistance of the tire. Thus, the benefit of maximum tread block compliance at the entrance and exit of contact, and the benefit of increasing tread block rigidity within the contact patch, both of which lower rolling resistance, are maximized while the penalty of having increased mass, which can lead to more hysteresis and higher rolling resistance, is minimized. Also, the positioning of the bridges allows for water movement within the lateral groove so that hydroplaning resistance is not decreased. As the tire wears, these bridges disappear at a time when the blocks are naturally more rigid and their presence is no longer needed. At this time, the lateral grooves are shallower and are now completely free of any obstructions, which allow the tire to maintains its hydroplaning resistance, while at the same time, no extra rubber is present, which also aids in reducing the rolling resistance of the tire.

Testing of a 225/50R17 sized tire that has split bridges found along the lateral surfaces of every tread block of the tire that are configured according to the guidelines given above, has revealed surprising and unexpected results. The tire exhibited a significant 2.6% reduction in tire rolling resistance. At the same time, the inventors of the present invention expected a statistically significant decrease in the speed at which hydroplaning occurred due to the volume of obstruction created by the additional rubber used to create these bridges. It was theorized that this would limit the flow of water in the lateral grooves, and by consequence, the absorption of water by the tire as it passes through puddles of water. Similarly, a reduction in snow traction was anticipated for similar reasons.

However, virtually identical hydroplaning results were achieved between a tire lacking the split bridges and a tire having the split bridges (hydroplaning speeds for the two configurations of tires were within 0.02 km/h of each other) using the following test procedure. The front wheels of a test vehicle having front wheel drive were then fitted with two tires—each having the same tread pattern. The test vehicle was driven through water having a controlled depth of 8 mm on an asphalt track at a speed of 50 kph. Preferably, this speed was maintained by using e.g., cruise control on the vehicle. Once the vehicle reached the validation area, the driver accelerated the vehicle as quickly as possible for 30-50 m (this distance is fixed as desired) to see if 10% slip could be generated between the speed of the drive wheels and the GPS speed of the vehicle. If 10% slip was achieved, this same test run was repeated three more times. If 10% slip was not achieved, then the test run was performed by adding 5 kph to the initial vehicle speed. This step was then repeated until 10% slip was achieved. Once the 10% slip was achieved, then another three runs at the same conditions as previously described was conducted. Usually, five total runs were made with the first and last runs being used for reference only. Data is then acquired from these runs and a statistically relevant calculation of the speed at which hydroplaning occurs, which corresponds to the vehicle speed at which 10% slip happens, is constructed. Using this data, a performance measurement result was created.

As previously stated, the speeds at which 10% slip occurred for a tire with the split bridges and a tire without the split bridges was virtually the same. Also, no statistically significant reduction in snow traction was observed. So, the apparent compromise between using bridging for improving rolling resistance versus detrimentally affecting hydroplaning resistance as well as snow traction has been broken.

While this invention has been described with reference to particular embodiments thereof, it shall be understood that such description is by way of illustration and not by way of limitation. For example, the present invention could be combined with classical groove bridges or chamfers could be added between the intersections of the top surface of the tread blocks and the lateral surfaces of the lateral grooves. Furthermore, particular dimensions have been given but it is well within the purview of one skilled in the art to make adjustments to these dimensions and still practice the spirit of the present invention. Accordingly, the scope and content of the invention are to be defined only by the terms of the appended claims.

What is claimed is:

1. An apparatus that comprises a tread for use with a tire having laterally and circumferentially extending grooves that define tread blocks, at least one of said tread blocks having a lateral surface that is located within one of said lateral grooves that has one or more split bridges thereon that do not make contact with the opposing tread block or any portion protruding therefrom, wherein:
the ratio of Dₜ/D_{g}, which is the ratio of the distance from the top of the tread to the top of a bridge to the depth of the lateral groove, is in the range of 10 to 40%;
the ratio of D_{b}/D_{g}, which is the ratio of the distance from the bottom of the lateral groove to the bottom of a bridge, is in the range of 15 to 50%;
the ratio of the aggregate widths, Wₜₒₜ, of the bridges found along this lateral surface to the width of this lateral surface, W_{b}, of the tread block is in the range of 30 to 80%; and
the ratio of the summation of the lateral surface areas, Sₜₒₜ, of the bridges to the surface area, S_{b}, of the lateral surface of a tread block is in the range of 10 to 40%.

2. The apparatus of claim 1 which further comprises split bridges that are found within a plurality of lateral grooves that are configured as described in claim 1.

3. The apparatus of claim 2 wherein all the lateral grooves have split bridges configured as described in claim 1.

4. The apparatus of claim 1 which further comprises a tire having a carcass and a summit belt package having a top belt and a bottom belt to which said tread is attached.

5. The apparatus of claim 4 wherein the tire defines a dimension E, which is the distance from the top portion of the top belt to the average position of the top surface of the split bridges in the radial direction of the tire, and another dimension F, which is the distance from the axis of rotation X-X of the tire to the average position of the top surface of the split bridges in the radial direction of the tire the ratio of E/F is in the range of 1.5% to 4%.

6. The apparatus of claim 4 wherein said tire is a 225/50R17 sized tire.

7. The apparatus of claim 1 wherein said one or more split bridges that extend from one lateral surface of a tread block found within a lateral groove has a counterpart split bridge that extends from the opposite lateral surface of an adjacent tread block such that a small gap is defined between the opposing split bridges.

8. The apparatus of claim 7 wherein in the gap is about 0.5 mm or less.

9. The apparatus of claim 7 wherein the end surface of one split bridge that defines the gap between the split bridges has an undulating profile for helping to limit lateral or radial movement of a tread block relative to its neighboring tread block when the tread block is in the contact patch.

10. The apparatus of claim 1 wherein the cross-sectional shape of a bridge is ovular.

11. The apparatus of claim 1 wherein the bridge has filleting radii from its intersection from the lateral surface of the tread block to it free end.

12. The apparatus of claim 2 wherein the plurality of split bridges found within a plurality of lateral grooves are in lateral alignment with each other.

13. The apparatus of claim 1 wherein the distance from the top of the tread to the top of a bridge, Dₜ, is in the range of between 0.5 to 2.5 mm while the distance from the bottom of a lateral groove to the bottom of a bridge, D_{b}, is in the range of 0.9 to 4.0 mm.

14. The apparatus of claim 13, wherein the depth, D_{g}, of the lateral groove is in the range of 5.5 to 10.0 mm.

15. The apparatus of claim 7 wherein the gap found between the opposing split bridges is located halfway across the width of the lateral groove.
